(19) United States
(12) Patent Application Publication
(10) Pub. No.: US 2026/0231966 A1
(43) Pub. Date: Aug. 13, 2026

(54) Poultry Hanging System and Method

(71) Applicant: Grover S. Harben, Gainesville, GA (US)

(72) Inventor: Grover S. Harben, Gainesville, GA (US)

(21) Appl. No.: 19/538,152

(22) Filed: Feb. 12, 2026

Related U.S. Application Data
(60) Provisional application No. 63/757,868, filed on Feb. 13, 2025.

(51) Int. Cl. A22C 21/00

(52) U.S. Cl. CPC A22C 21/0053; A22C 21/0007

(57) ABSTRACT

This invention relates to systems and methods for hanging live poultry for further processing. The system has an alignment conveyor, a hanging station, and a shackle. The conveyor conveys poultry from an input point to the hanging station. A hanging box of the hanging station grasps the poultry and rotates the poultry to an inverted position in which legs of the bird extend upwards and away from the hanging box. A shackle moves past the hanging box so that the shackle engages the legs of the bird and then transports the bird through the processing facility. A processor and at least one sensor control operation of the system so that human intervention is minimized.

### CROSS-REFERENCE TO RELATED APPLICATIONS

This application claims the benefit of and priority to U.S. Provisional Patent 63/757,868, filed Feb. 13, 2025, which is incorporated in its entirety in this document by reference.

### FIELD OF THE INVENTION

This invention relates to systems and methods for hanging live poultry. More particularly, this invention relates to automated systems and methods for hanging live poultry for processing.

### BACKGROUND OF THE INVENTION

Poultry processing plants have become automated to a large extent. Due to federal regulations, it is necessary to kill the birds while they are in an inverted configuration so that the blood is pumped from the birds' body via their own heart. Typically, birds are processed in an inverted position with their hocks suspended by shackles pivotally mounted to an overhead conveyor line. This orientation places the tail region roughly midway down the bird body while the pivotal mounting enables the birds to be manipulated along the process line. It is common practice to electrically stun the birds prior to processing them while they are inverted and shackled. In this manner, the birds, while alive, remain relatively motionless for processing.

Conventionally, suspending the bird from the shackles is a manual process. For example, depending on the speed of the overhead conveyor line, several employees can be required to restrain the bird, orient the bird correctly relative to the shackles of the conveyor, and place the bird into the shackles. Because the birds are alive, manually loading the birds into the shackles can be a cumbersome and unsanitary task. Therefore, there is a need in the industry for a system or apparatus to automatically hang live poultry for processing. The present invention fulfills these needs and provides further related advantages as describe herein.

### SUMMARY

The application relates to systems and methods for hanging live poultry, such as a chicken, quail, turkey, duck and the like. In one aspect, the system for hanging live poultry can comprise at least one of an alignment conveyor, at least one hanging station comprising a hanging box, and at least one shackle on a picking line. The alignment conveyor can convey birds from an input point in the processing facility to the hanging station. In another aspect, the hanging box of the hanging station can grasp a bird from the conveyor and rotate the bird upside down such that legs of the bird are extending upwards. The shackle can slide past the hanging box so that the legs of the bird are positioned into slots defined in the shackle. The shackle can then transport the bird throughout the facility for further processing. In one aspect, it is contemplated that a processor can be configured to control operation of the system so that human intervention is minimized. The system can also comprise at least one sensor that is operatively coupled to the processor.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION OF THE FIGURES

These and other features of the preferred embodiments of the invention will become more apparent in the detailed description in which reference is made to the appended drawings wherein:

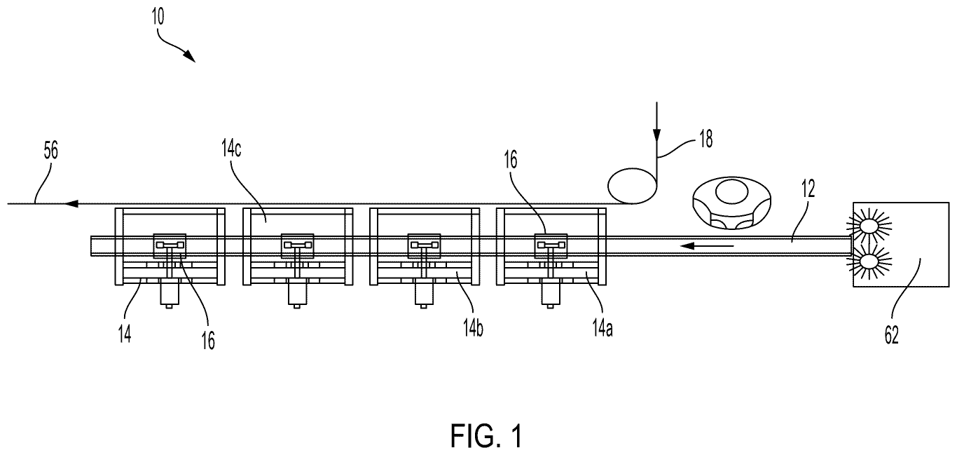

FIG. 1 is a schematic diagram of a system for hanging live poultry, according to one aspect comprising a conveyor, at least one hanging station and at least one shackle.

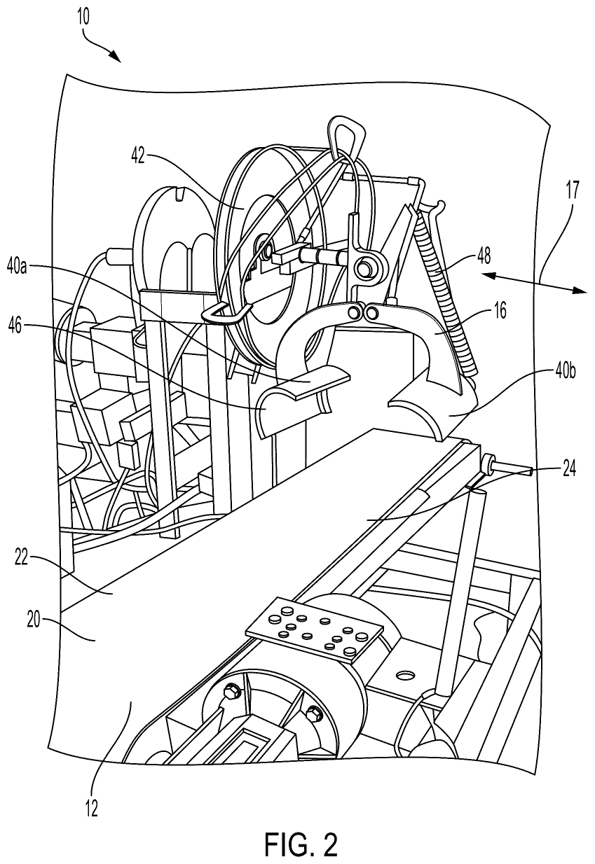

FIG. 2 is a perspective view of the system of FIG. 1 showing the hanging box in an open and grasping position.

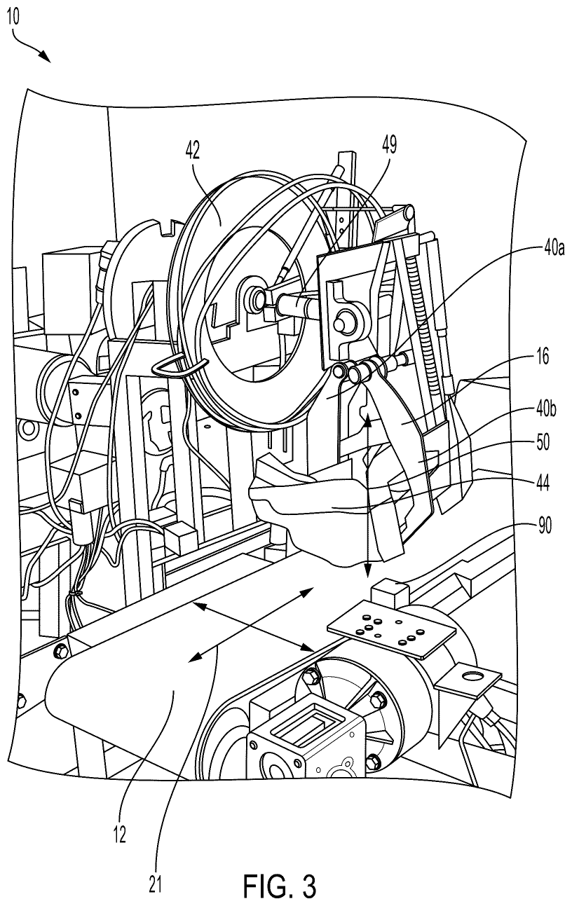

FIG. 3 is a perspective view of the system of FIG. 1 showing the hanging box in a closed and grasping position.

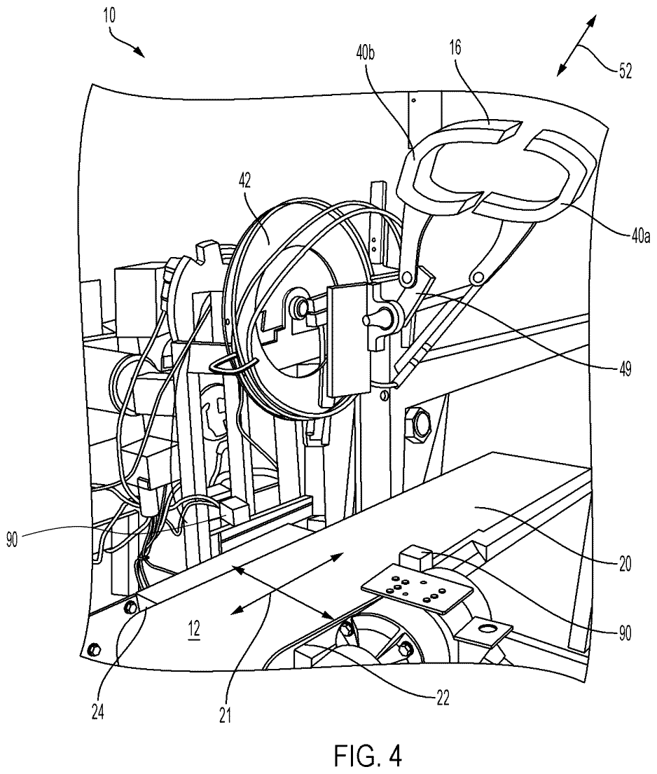

FIG. 4 is a perspective view of the system of FIG. 1 showing the hanging box in a closed and picking position.

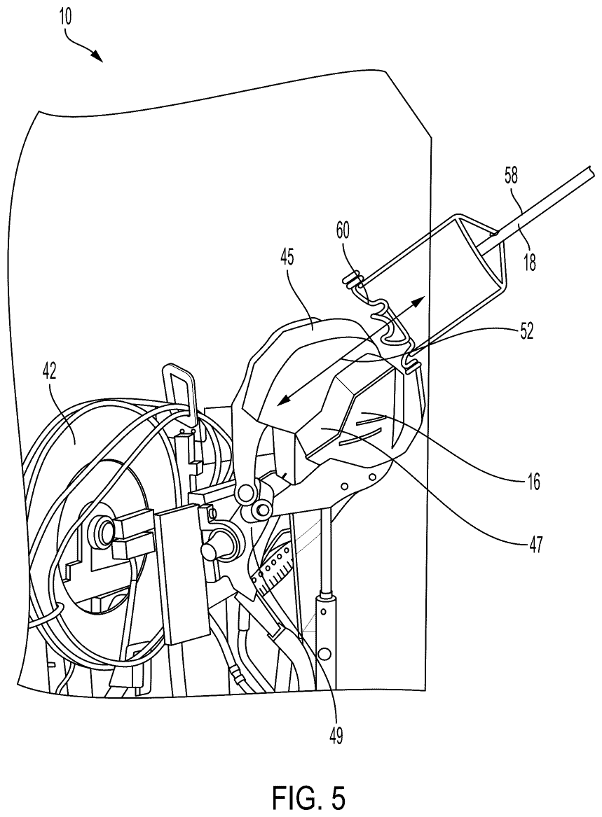

FIG. 5 is perspective view a portion of the system of FIG. 1 showing the hanging box in a closed and picking position and the shackle configured to pick the poultry.

### DETAILED DESCRIPTION OF THE INVENTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “an element” can include two or more such elements unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The application relates to systems and methods for hanging live poultry, such as a chicken, quail, turkey, duck and the like. In one aspect, as illustrated in FIGS. 1-5, the system 10 for hanging live poultry can comprise at least one of an alignment conveyor 12, at least one hanging station 14 comprising a movable hanging box 16, and at least one shackle 18. As will be described more fully below, the alignment conveyor 12 can transport at least one bird 44 to a predetermined location. The hanging box 16 can then grasp the bird 44 and place it in the shackle 18 for further processing.

In one aspect, the alignment conveyor 12 can be an endless conveyor that can be conventionally trained around a plurality of conveyor rollers. It is contemplated that the endless conveyor 12 can comprise a conventional design. In one non-limiting example, at least one of the conveyor rollers can be driven by a motor or drive, which causes the alignment conveyor 12 to rotate about the conveyor rollers at a desired and selectable conveyor speed in a conveyor direction. In another aspect, during at least a portion of the course of the endless conveyor path, at least a portion of the conveyor 12 direction can be substantially linear along an alignment conveyor axis. In yet another aspect, during at least a portion of the course of the endless conveyor path, an upper surface 20 of the conveyor 12 can be positioned in a conveyor plane 21 that is substantially parallel to a floor on which the conveyor 12 is placed. Optionally, during at least a portion of the course of the endless conveyor path, the conveyor plane 21 can be positioned at an acute angle relative to the floor on which the alignment conveyor 12 is placed. For example, a first side 22 of the alignment conveyor can be higher than a second side 24 relative to the floor.

The at least one hanging station 14 can be configured for grasping a bird 44 moving along the conveyor 12 and positioning the grasped bird 44 for pickup by a shackle 18 moving in a picking line 56 above the hanging station 14.

In one aspect, the hanging box 16 of the hanging station 14 can comprise a first side 40a and an opposed second side 40b. In this aspect, the first side 40a and the second side 40b can cooperate to securely grasp the bird 44 between the first side 40a and the opposed second side 40b. In another aspect, at least one of the first side 40a and the second side 40b can be movable sides positioned above the upper surface 20 of the conveyor 12. In still another aspect, at least one of the first side 40a and the second side 40b can be movable about and between a first, open position, in which the first side 40a is spaced from the second side 40b a first predetermined distance (as shown in FIG. 2), and a second, closed position in which the first side 40a and the second side 40b are spaced from each other a second predetermined distance that is less than the first predetermined distance (as shown in FIGS. 3 and 4). Thus, in this aspect, the distance between the opposed sides 40a, b can vary. For example, in the first, open position, a bird 44 can easily pass between the sides 40a, b, while in the second, closed position, the sides 40a, b can securely grasp the bird 44. Alternatively, one of the first side 40a and the second side 40b can be fixed relative to the other side, and the other side can be movable about and between the first, open position and the second, closed position.

In another aspect, in the second, closed position, the hanging box 16 can be spaced a predetermined height above the upper surface 20 of the conveyor 12. In this aspect, the predetermined height can be selected so that the first side 40a and the second side 40b securely grasp the body of the bird 44, but do not grasp the legs of the bird. That is, with the bird 44 grasped by the first side 40a and the second side 40b while in the second, closed position, the legs of the bird 44 extend below the first side 40a and the second side 40b.

In one aspect, an inner surface 46 of at least one of the first side 40a and the second side 40b can be arcuate in shape to better conform to the shape of the bird 44. In another aspect, the inner surface 46 of the first side 40a and the second side 40b can be shaped to engage and/or control the wings of the bird 44, which can calm the bird 44. Calming the bird 44 can then enable the system 10 to more successfully and reliably place birds 44 into a shackle 18. In another aspect, the inner surface 46 of at least one of the first side 40a and the second side 40b can be covered in a padded material 45 to protect the bird 44 as the bird 44 is grasped by the hanging box 16. In yet another aspect, the inner surface 46 of at least one of the first side 40a and the second side 40b can be covered in a non-slip material 47 to make escape from the hanging box 16 more difficult for the bird 44.

As can be appreciated, conventional gears, motors, cams, springs and the like can be utilized to urge movement of the opposed sides 40a, b of the hanging box 16 as desired. For example, a motor, a spring 48 and the like can be used to urge the opposed sides 40a, b from the second, closed position to the first, open position. In another example, a motor, a spring 48 and the like can be used to urge the first side 40a and the second side 40b from the first, open position to the second, closed position.

In one aspect, the hanging station 14 further comprises a rotation device 42 configured to rotate the bird 44 from a standing position to an inverted position. In this aspect, the rotation device 42 can comprise a rotatable arm 49 coupled to the hanging box 16. As such, the rotatable arm 49 can enable the hanging box 16 to be rotatable from a first, grasping position located adjacent to the conveyor 12 (as shown in FIG. 3), to a second, picking position that is spaced from the conveyor 12 and adjacent to a shackle 18 in the picking line 56 (as shown in FIGS. 4 and 5). That is, in the first, grasping position, a lowest portion of the first side 40a and the second side 40b of the hanging box 16 are spaced a first grasping distance from the upper surface 20 of the conveyor 12, and in the second, picking position, a lowest portion of the first side 40a and the second side 40b are spaced a second picking distance from the upper surface 20 of the conveyor 12. As can be appreciated, the second, picking distance is greater than the first, grasping distance.

In use, described more fully below, in the first, grasping position, the first side 40a and the second side 40b of the hanging box 16 can move to the second, closed position to grasp the bird 44. The hanging box 16 can then move the bird 48 from the first, grasping position to the second, picking position in which a shackle 18 traveling in the picking line 56 can secure the legs of the bird 44. After the bird 44 has been pulled from the hanging box 16 by the shackle 18, the hanging box 16 can rotate from the second, picking position back to the grasping position to prepare to secure another bird 44.

A bird 44 positioned in the hanging box 16 while the hanging box 16 is in the first, grasping position can be standing upright with the feet of the bird 44 on the conveyor 12 and the legs of the bird 44 extending between the hanging box 16 and the conveyor 12. In one aspect, in the second, picking position, the hanging box 16 can be rotated approximately 180 degrees relative to the first, grasping position (about a rotation axis 17 that is substantially parallel to the conveyor plane) such that the legs of the bird 44 are positioned above the body of the bird 44 and the legs of the bird 44 extend above the hanging box 16. In the second, picking position, the bird 44 can be rotated substantially upside down. In other aspects, in the second, picking position, the hanging box 16 can be rotated about 175 degrees, about 170 degrees, about 165 degrees, about 160 degrees, about 155 degrees, about 150 degrees, about 145 degrees, about 140 degrees, about 135 degrees, about 130 degrees, about 125 degrees, about 120 degrees, about 115 degrees, about 110 degrees, about 105 degrees, about 100 degrees, about 95 degrees, about 90 degrees, or less than about 90 degrees relative to the first, grasping position.

As can be appreciated, conventional gears, motors, cams, springs and the like can be utilized to urge rotation of the hanging box 16 as desired about and between the rotation axis 17. In one aspect, the hanging box 16 can rotate in the direction of travel of the conveyor 12 when rotating from the first, grasping position to the second, picking position. In another aspect, after the bird 44 has been picked from the hanging box 16 by the shackle 18, the hanging box 16 can rotate in the same rotational direction when moving from the second, picking position back to the first, grasping position. For example, if the conveyor 12 shown in FIG. 2 is traveling from left to right, the hanging box 16 can rotate counter-clockwise when rotating from the first, grasping position to the second, picking position. To move back to the first, grasping position in order to grasp another bird 44, the hanging box 16 can rotate counter-clockwise to move from the second, picking position back to the first, grasping position. Alternatively, the hanging box 16 can rotate in the opposite direction of travel of the conveyor 12 when rotating from the first, grasping position to the second, picking position. For example, if the conveyor 12 shown in FIG. 2 is traveling from left to right, the hanging box 16 can rotate clockwise when rotating from the first, grasping position to the second, picking position. Similarly, the hanging box 16 can rotate in the opposite direction of travel of the conveyor 12 when moving from the second, picking position back to the first, grasping position. For example, if the conveyor 12 shown in FIG. 2 is traveling from left to right, the hanging box 16 can rotate clockwise when rotating from the second, picking position back to the first, grasping position.

In one aspect, in the first, grasping position, the hanging box 16 can be positioned along a first hanging box axis 50 that is substantially normal to the upper surface 20 of the conveyor 12. That is, in the first, grasping position, the first side 40a and the second side 40b of the hanging box 16 can be spaced substantially evenly about the first hanging box axis 50 at substantially a right angle to the conveyor plane 21. In the second, picking position, the hanging box 16 can be positioned in a second hanging box axis 52 that is at an acute angle relative to the first hanging box axis 50 and to the conveyor plane 21. That is, in the second, picking position, the first side 40a and the second side 40b of the hanging box 16 can be spaced substantially evenly about the second hanging box axis 52 at an acute angle relative to the first hanging box axis 50 and to the conveyor plane 21.

In another aspect, in the first, grasping position, the first hanging box axis 50 can be substantially aligned with a midpoint of the conveyor 12. That is, in the first, grasping position, the hanging box 16 can be substantially centered relative to the width of the conveyor 12. In the second, picking position, the hanging box 16 can be substantially aligned with the first hanging box axis 50 (that is, centered above the conveyor 12). Alternatively, however, in the second, picking position, the hanging box 16 can be offset a predetermined distance from the midpoint of the conveyor 12. In one aspect, in the second, picking position, the hanging box 16 can be offset from the midpoint of the conveyor 12 such that at least a portion of the hanging box 16 does not overlie the conveyor 12.

Moreover, in the second, picking position with the bird 44 secured by the hanging box 16 and with the legs of the bird 44 extending beyond the first side 40a and the second side 40b of the hanging box 16, the hanging box 16 can be rotated or positioned as desired so that the hanging box 16 can engage 18 shackles moving in various system configurations. For example, with the bird 44 upside down, the hanging box 16 can rotate about a vertical axis that is substantially perpendicular to the first axis as needed so that the legs of the bird 44 can engage a shackle 18.

The shackle 18 can be an articulating shackle 54 coupled to a picking line 56 of the processing facility. In one aspect, the shackle 18 can comprise a fixed hanging 58 portion coupled to the picking line 56, and an articulating hanging portion 60 rotatably coupled to the fixed hanging portion 58.

In one aspect, the system 10 further comprises at least one sensor or switch 90 electrically coupled to a control system (not shown). In this aspect, the sensor or switch 90 can be a proximity sensor configured to sense the absence or presence of an object, according to one aspect. In another aspect, the sensor or switch 90 can be a photoelectric sensor configured to sense the absence or presence of an object by using a light transmitter and a photoelectric receiver. In a further aspect, the sensor or switch 90 can be an encoder coupled to a shaft or to a motor and configured to sense the rotational speed of the shaft or motor. In still a further aspect, the sensor or switch 90 can be a force sensor or transducer coupled to the system 10 and configured to sense a torsional force.

In one aspect, the control system can comprise a processor electrically coupled to the at least one sensor or switch 90 and programmed to selectively monitor, display, set and/or control at least one of the operating parameters of the hanging system 10. In another aspect, the processor can be electrically coupled to at least one of the conveyor 12, the hanging station 14, and the picking line 18. Thus, in one aspect, the processor can be configured to actuate the system 10 so that a bird 44 traveling on the conveyor 12 can be grasped by a hanging box 16 and placed into a shackle 18.

For example, a speed of the conveyor belt 12 can be set by an operator of the system 10. The sensor 90 can sense the speed and/or presence of a bird 44 on the conveyor 12 and can send this information to the processor. Based on the speed of the conveyor 12, the processor can actuate the hanging box 16 and close the sides 40a, b of the hanging box 16 at the appropriate time to capture the bird 44. The hanging box 16 can then swing around and up to turn the bird 44 upside down and hold the bird 44 into position for the shackle 18 to catch the bird 44 and move the bird along the picking line 56.

In another example, when the hanging box 16 is in the second, picking position with the bird 44 secured by the hanging box 16 and with the legs of the bird 44 extending into the shackle 18, a force exerted by the shackle 18 onto the bird 44 and into the hanging box 16 can be sensed by the sensor 90. The processor can actuate the hanging box 16 and open the sides 40a, b of the hanging box 16 at the appropriate time to release the bird 44 from the hanging box 16. Alternatively, when the hanging box 16 is in the second, picking position with the bird 44 secured by the hanging box 16 and with the legs of the bird 44 extending into the shackle 18, a force exerted by the shackle 18 onto the bird 44 and into the hanging box 16 can cause at least a portion of the system 10 to rotate or twist slightly. A switch 90 can positioned so that this rotation or twist can trigger the switch 90 so that the processor can actuate the hanging box 16 and open the sides 40a, b of the hanging box 16 at the appropriate time to release the bird 44 from the hanging box 16.

The system 10 for hanging live poultry can be formed from conventional materials, such as for example and without limitation, polymeric materials and/or stainless steel.

The conveyor 12 can be a high-speed conveyor 12 that conveys birds 44 to the at least one hanging station 14 at a higher rate of speed than can be grasped by the hanging station 14. In one aspect, the at least one hanging station 14 can comprise a plurality of hanging station 14 positioned one after another along the conveyor 12 as shown in FIG. 1. In this aspect, a first hanging station 14a can secure a first bird, and a second bird can travel on the conveyor 12 past the first hanging station 14a to be secured by a second hanging station 14b positioned downstream of the first hanging station 14a. A third bird can travel on the conveyor 12 past the first hanging station 14a and the second hanging station 14b to be secured by a third hanging station 14c positioned downstream of the first hanging station 14a and the second hanging station 14, and so on for any number of hanging stations 14. There can be for example, two, three, four, five, six, seven, eight, nine, ten or more than ten hanging stations 14 positioned one after another along the conveyor 12. In one aspect, when the hanging box 16 of a hanging station 14 is in the second, picking position, a bird 44 on the conveyor 12 can be conveyed past that hanging station 14 undisturbed. For example, if the hanging box 16 of the first hanging station 14a is in the second, picking position so that a first bird 44 can be placed into a shackle 18, a second bird 44 can be conveyed undisturbed past the first hanging station 14a to the second hanging station 14b. Similarly, a third bird can be conveyed undisturbed past the first hanging station 14a and the second hanging station 14b to the third hanging station 14c when the hanging box 16 of the first hanging station 14a and the hanging box 16 of the second hanging station 14b are in the second, picking position. This process can continue until the hanging box 16 of the first hanging station 14a is ready to hang another bird 44.

In order to use the system 10 for hanging live poultry, it is contemplated that the birds 44 can be fed to the alignment conveyor 12 by conventional means. For example and without limitation, the birds 44 can be loaded from delivery trucks into a hopper or other storage device 62. The hopper or storage device 62 can feed or otherwise urge the birds 44 to the alignment conveyor 12 such that the birds 44 are spaced and oriented as desired. Optionally, a user can place birds 44 from the storage device 62 onto the conveyor 12 such that the birds 44 are spaced and oriented as desired. In one aspect, a combination of a user and mechanical devices can place birds 44 from the storage device 62 onto the conveyor 12 such that the birds 44 are spaced and oriented as desired.

As the birds 44 travel on the alignment conveyor 12 at a conveyor speed, the hanging box 16 can be in the first, grasping position or the hanging box 16 can be rotating towards the first grasping position. When the bird 44 traveling on the conveyor 12 arrives at the hanging box 16, the hanging box 16 can be moving at a hanging box speed that is substantially the same speed and in the same direction as the conveyor belt speed. In one aspect, then, when the bird 44 traveling on the conveyor 12 arrives at the hanging box 16, the conveyor 12, the bird 44 and the hanging box 16 can all be moving at the substantially the same rate of speed and in the same direction. With the bird 44 in position, the first side 40a and the second side 40b of the hanging box 16 can move from the first, open position to the second, closed position in which the opposed sides 40a, b can securely grasp the bird 44. Note that movement of the first side 40a and/or the second side 40b can begin before the bird 44 actually reaches the hanging box 16 as necessary based on the speed of the conveyor 12.

After the bird 44 has been grasped by the hanging box 16, the hanging box 16 can move from the first, grasping position to the second, picking position in which the hanging box 16 (with the bird 44 grasped therein) can be brought adjacent to the picking line 56. Because the hanging box 16 is in the second, picking position, the legs of the bird 44 can be positioned above the first side 40a and the second side 40b. The articulating hanging portion 60 of a shackle 18 can engage the hanging box 16 so that the articulated hanging portion 60 is urged into position such that the shackle 18 slides past the bird 44 and that each leg of the bird 44 slides into a slot formed in the shackle 18. The bird 44, pulled by the shackle 18, causes the hanging box 16 to slightly rotate or twist which can trigger the switch 90. The switch 90 then can transmit a signal to the processor that causes the first side 40a and/or the second side 40b of the hanging box 16 to move from the second, closed position towards the first, open position so that the bird can be released from the hanging box 16. The shackle 18, with the bird 44 attached, can then be moved by the picking line 56 away from the hanging box 16. The picking line 56 can then transport the bird 44 through the processing facility for conventional processing.

After the bird 44 has been pulled from the hanging box 16 by the shackle 18, the hanging box 16 can rotate from the second, picking position back towards the first grasping position. At any time after the bird 44 has been pulled, the hanging box 16 can begin moving from the second, closed position back to the first, open position.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

What is claimed is:

1. A poultry hanging system for moving standing birds from an input point in a processing facility to a picking line, the birds each having a head and two legs, the poultry hanging system comprising:
an alignment conveyor having an upper surface;
at least one hanging station positioned above the upper surface of the alignment conveyer and comprising a hanging box configured to securely grasp a bird; and
at least one shackle coupled to the picking line that is positioned above the at least one hanging station,
wherein the alignment conveyor conveys the bird from the input point to the at least one hanging station, and wherein the at least one hanging station rotates the bird so that the legs of the bird are positioned above the head and positions the grasped bird for pickup by the at least one shackle.

2. The poultry hanging system of claim 1, wherein the hanging box comprises a first side and an opposed second side that cooperate to securely grasp the bird between the first side and the opposed second side.

3. The poultry hanging system of claim 2, wherein at least one of the first side and the second side is movable about and between a first, open position, in which the first side is spaced from the second side a first predetermined distance, and a second, closed position in which the first side and the second side are spaced from each other a second predetermined distance that is less than the first predetermined distance.

4. The poultry hanging system of claim 3, wherein in the first, open position, the alignment conveyer conveys the bird between the first side and the second side, and wherein in the second, closed position, the first side and the second side cooperate to securely grasp the bird therebetween.

5. The poultry hanging system of claim 4, wherein in the second, closed position, the first side and the second side are spaced a predetermined height above the upper surface of the conveyor, and wherein the predetermined height is selected so that the first side and the second side securely grasp a body of the bird such that the legs of the bird extend outward and away from the hanging box.

6. The poultry hanging system of claim 5, wherein the at least one hanging station further comprises a rotation device configured to rotate the bird from a standing position to an inverted position in which the legs of the bird are positioned above the head of the bird.

7. The poultry hanging system of claim 6, wherein the rotation device comprises a rotatable arm coupled to the hanging box, wherein the rotatable arm enables the hanging box to be rotatable from a first, grasping position located adjacent to the conveyor to a second, picking position that is spaced from the conveyor and adjacent to the at least one shackle.

8. The poultry hanging system of claim 7, wherein in the first, grasping position, a lowest portion of the first side and the second side of the hanging box are spaced a first grasping distance from the upper surface of the conveyor, and in the second, picking position, a lowest portion of the first side and the second side are spaced a second picking distance from the upper surface of the conveyor that is greater than the first, grasping distance.

9. The poultry hanging system of claim 8, wherein the upper surface of the conveyor is positioned in a conveyor plane that is substantially parallel to a floor on which the conveyor is positioned, and wherein the hanging box is rotatable about and between a rotation axis that is substantially parallel to the conveyor plane.

10. The poultry hanging system of claim 7, wherein the hanging box is rotatable in a direction of travel of the conveyor when rotating from the first, grasping position to the second, picking position.

11. The poultry hanging system of claim 7, wherein the at least one shackle is an articulating shackle comprising a fixed hanging portion coupled to the picking line, and an articulating hanging portion rotatably coupled to the fixed hanging portion.

12. The poultry hanging system of claim 11, wherein in the second, picking position, the legs of the bird are positioned into slots defined in the articulating hanging portion of the at least one shackle.

13. The poultry hanging system of claim 7, wherein the at least one hanging station comprises a plurality of hanging stations positioned one after another along the conveyor.

14. The poultry hanging system of claim 13, wherein the plurality of hanging stations comprises a first hanging station and a second hanging station, and wherein the first hanging station grasps a first bird, and a second bird travels on the conveyor past the first hanging station to be grasped by the second hanging station.

15. The poultry hanging system of claim 14, wherein the second bird travels on the conveyor past the first hanging station to be grasped by the second hanging station when the hanging box of the first hanging station is in the second, picking position.

16. The poultry hanging system of claim 7, wherein the poultry hanging system further comprises a control system comprising at least one proximity sensor configured to sense the presence of a bird.

17. A method for hanging birds in a processing facility having an input point and a
picking line, the birds each having a head and two legs, the method comprising:
providing a hanging system comprising:
an alignment conveyor having an upper surface;
at least one hanging station positioned above the upper surface of the alignment conveyer and comprising a hanging box configured to securely grasp a bird; and
at least one shackle coupled to the picking line that is positioned above the at least one hanging station,
wherein the alignment conveyor conveys the bird from the input point to the at least one hanging station, and wherein the at least one hanging station rotates the bird so that the legs of the bird are positioned above the head, and positions the grasped bird for pickup by the at least one shackle;
positioning a bird on the alignment conveyor adjacent to the input point;
conveying the bird on the alignment conveyor from the input point to the at least one hanging station;
moving at least one of a first side and a second side of the hanging box from a first, open position in which the first side is spaced from the second side a first predetermined distance to a second, closed position in which the first side and the second side are spaced from each other a second predetermined distance that is less than the first predetermined distance to grasp the bird therebetween the first side and the second side;
rotating the hanging box and the bird from a first, grasping position located adjacent to the conveyor, to a second, picking position that is spaced from the conveyor and adjacent to the at least one shackle;
sliding the at least one shackle past the bird so that each leg of the bird is positioned into a slot formed in the at least one shackle.

18. The method of claim 17, wherein the at least one hanging station further comprises a rotation device configured to rotate the bird from a standing position to an inverted position in which the legs of the bird are positioned above the head of the bird.

19. The method of claim 18, wherein the at least one hanging station comprises a first hanging station and a second hanging station positioned downstream of the first hanging station, and wherein the first hanging station grasps a first bird, and a second bird travels on the conveyor past the first hanging station to be grasped by the second hanging station.

20. The method of claim 19, wherein the second bird travels on the conveyor past the first hanging station to be grasped by the second hanging station when the hanging box of the first hanging station is in the second, picking position.
